(19) United States
(12) Patent Application Publication
(10) Pub. No.: US 2007/0016478 A1
(43) Pub. Date: Jan. 18, 2007

(54) Method of providing see-through advertisements on a retail display cabinet

(75) Inventor: G. Roland Hill, Stockport (GB)

Correspondence Address: PILLSBURY WINTHROP SHAW PITTMAN, LLP, P.O. BOX 10500, MCLEAN, VA, 22102, US

(73) Assignee: Contra Vision, Ltd., Stockport (GB)

(21) Appl. No.: 11/485,963

(22) Filed: Jul. 14, 2006

Related U.S. Application Data
(60) Provisional application No. 60/698,942, filed on Jul. 14, 2005.

(51) Int. Cl. G07G 1/14

(52) U.S. Cl. 705/14

(57) ABSTRACT

A one-way vision and/or see-through advertisement panel is provided on the transparent panel of a door of a retail display cabinet. The advertisement panel allows a substantially unobstructed view through the advertisement to a product inside the cabinet from an outer side of the transparent panel. A see-through advertisement panel may be visible from an inner and/or an outer side of the transparent panel. A one-way vision advertisement may be substantially invisible from outside the transparent panel, but visible when a customer opens the door and views inside the door. The advertiser may directly or indirectly pay the retailer or the entity whose products are displayed in the cabinet in exchange for permission to place an advertisement on the transparent panel of the cabinet door. The advertiser may be the retailer or the entity whose products are displayed in the cabinet.

### CROSS-REFERENCE

This application claims priority to U.S. Provisional Application Ser. No. 60/698,942, titled “METHOD OF PROVIDING SEE-THROUGH ADVERTISEMENTS ON A RETAIL DISPLAY CABINET,” filed Jul. 14, 2005, the entire contents of which are hereby incorporated by reference.

### BACKGROUND OF THE INVENTION

1. Field of the Invention

This invention relates to methods of placing advertisements on retail display cabinets.

2. Description of Related Art

Retail display cabinets are conventionally used to store and display merchandise in retail stores. Such retail cabinets are frequently coolers or freezers that are used to chill the products displayed therein. Retail cabinets frequently include transparent doors that enable customers to see into the cabinet to identify products for purchase.

The positioning of products on retail shelving in retail stores, whether open shelves or in display cabinets, is subject to intense competition, in order to obtain preferred shelves. The best shelves are typically thought to be at or just below eye height (e.g., between the heights of 4 and 6 feet). A retail store owner often receives a premium for such preferred shelf space from the entity (e.g., product manufacturer, product reseller, etc.) whose product occupies the preferred shelf space.

This preferred shelving space is also preferred advertising space because it is at a customer's eye level. Accordingly, opaque (or otherwise visually obstructing) advertisements have been conventionally placed on retail cabinet doors to take advantage of the customer's eye-level view. Unfortunately, such advertisements obscure customers' views into the display cabinet and may distract a customer from viewing the products displayed within the cabinet.

Another disadvantage to the placement of advertisements on retail cabinet doors is that a first entity that has paid to have its products displayed on premium shelf space does not want a second entity's advertisement to obscure the premium view to the first company's product. Accordingly, such first entities have conventionally prevented any other entity from placing advertisements on display cabinet doors in front of the first entities' products.

Retail store owners have also conventionally rejected such on-door advertisements because the retailer does not want point-of-purchase advertising to clutter the retail environment and potentially distract customers from making purchases.

Retailers typically own the display cabinets in their retail stores and are typically concerned with the application of self-adhesive advertisements by others, which may be done haphazardly. Self-adhesive advertisements include a range of different types of adhesive, some of which may transfer onto the transparent panel of the door upon removal of the advertisement. This causes unsightliness and increases the retailer's maintenance costs of cleaning the display cabinets and may even damage transparent plastic doors through chemical interaction of the adhesive or cleaning fluid with the plastic or scratching caused by the difficulty of removing transferred adhesive. There are therefore several retailer objections to such advertisements.

One-way vision panels, for example according to U.S. RE37,186 which is hereby incorporated by reference herein in its entirety, typically comprise a transparent material. The transparent material is typically partially printed with a “silhouette pattern,” for example a pattern of dots or lines, onto which is superimposed a design which is visible from one side of the panel and not visible from the other side of the panel. The other side of the panel is typically colored darkly (e.g., black) to allow good visibility through the unprinted portions of the transparent material. See-through graphic panels according to U.S. RE37,186 alternatively comprise a second design which is visible from the other side of the panel but is not visible from the one side of the panel. It is typically possible to also see through the panel from the design side. An observer's brain can select to concentrate on the design or to see through the design, through the unprinted portions of the transparent material.

See-through graphic panels which can be illuminated from either side or both sides, for example according to U.S. Pat. No. 6,212,805, which is hereby incorporated by reference herein in its entirety, typically comprise a transparent material. The transparent material is typically partially printed with a “base pattern,” for example a white layer in a pattern of dots or lines, onto which is superimposed a design which is visible from one side of the panel and a reverse (mirror) image of the design is visible from the other side of the panel when the panel is sufficiently illuminated from either side or both sides of the panel. Typically, an observer's brain can select to concentrate on the design or to see through the design, through the unprinted portions of the transparent material. Typically, at least 40% of the area of the transparent material is unprinted.

The dots or lines or other elements of the “silhouette pattern” of U.S. RE37,186 or the “base pattern” of U.S. Pat. No. 6,212,805 are independent of the design. If an observer standing close to either type of panel moves away from the panel, a position is reached at which the observer can see the design but can no longer discern individual dots, lines or other elements of the pattern. Through visibility is provided through the transparent portions between the dots, lines or other elements of the pattern.

Discrete non-transparent indicia applied to a transparent material are known, allowing vision around the individual indicia and enclosed portions of individual indicia, for example the inside of a letter “O”.

### SUMMARY OF THE INVENTION

Accordingly, one aspect of one or more embodiments of the present invention provides a method of advertising by placing an inwardly-facing, one-way vision advertisement on a retail display cabinet door panel. The one-way vision aspect of the advertisement avoids distracting customers who peer into display cabinets from the outer side of the display cabinet's door. Only after the door is open does the advertisement become clearly visible to the customer. The advertisement may be placed at or near customers' eye level in order for the advertisement to have the most visual impact on the customer who opens the door and sees the advertisement on the inside of the door. However, the advertisement may alternatively be placed at any other suitable height.

Another aspect of one or more embodiments of this invention provides a method of advertising on retail display cabinets that provides economic incentives to allow such advertisements.

Another aspect of one or more embodiments of this invention provides a method of providing an advertisement on a retail display cabinet having a door with a transparent panel. The cabinet contains at least one product supplied by a first entity. The method includes obtaining permission from the first entity to place an advertisement panel on the transparent panel. The method also includes placing on the transparent panel a one-way vision, see-through advertisement panel having the advertisement thereon. The advertisement panel has less than an 80 percent opacity to allow viewing of the at least one product through the advertisement from an outer side of the transparent panel. According to one or more embodiments, at least 40% of the area of the transparent material is unprinted. The advertisement is visible from an inner side of the transparent panel, but is substantially invisible from an outer side of the transparent panel.

Another aspect of one or more embodiments of this invention provides a method of providing an advertisement on a retail display cabinet having a door with a transparent panel. The cabinet contains at least one product supplied by a first entity. The method includes obtaining permission from the first entity to place an advertisement panel on the transparent panel. The method also includes placing on the transparent panel a see-through advertisement panel having the advertisement thereon. The advertisement is visible from an outer side of the transparent panel. The advertisement panel has less than an 80 percent coverage of the transparent panel to allow viewing of the at least one product through the advertisement from an outer side of the transparent panel. According to one or more embodiments, at least 40% of the area of the transparent material is unprinted.

According to a further aspect of one or more of these embodiments, the method also includes providing consideration to the first entity in exchange for granting permission to place the advertisement panel on the transparent panel. The method may also include leasing advertising space on the transparent panel to a second entity, wherein the advertisement promotes a product or service of the second entity.

According to a further aspect of one or more of these embodiments, the cabinet is disposed in a retail store and the method further includes obtaining permission from the owner of the retail store to place the advertisement panel on the transparent panel. The method may also include providing consideration to the owner of the retail store in exchange for granting permission to place the advertisement panel on the transparent panel.

According to a further aspect of one or more of these embodiments, the advertisement promotes a product or service of a second entity. The cabinet may be disposed in a retail store, and the second entity may be the owner of the retailer store.

According to a further aspect of one or more of these embodiments, the advertisement promotes a product or service of the first entity.

According to a further aspect of one or more of these embodiments, the cabinet is disposed in a retail store, the first entity is the owner of the retailer store, and the at least one product is a brand of the first entity.

According to a further aspect of one or more of these embodiments, the cabinet is disposed in a retail store, and the advertisement promotes a product or service available in the retail store or outside of the retail store.

Another aspect of one or more embodiments of this invention provides a method of advertising that includes placing a product in a retail display cabinet having a door with a transparent panel, and placing on the transparent panel a one-way vision, see-through advertisement panel having an advertisement thereon. The advertisement panel allows a substantially unobstructed view through the advertisement to the product from an outer side of the transparent panel. The advertisement is visible from an inner side of the transparent panel, but is substantially invisible from an outer side of the transparent panel. An entity whose product is placed in the cabinet is the entity whose advertisement is placed on the transparent panel. The advertisement promotes a product or service in a location outside the cabinet. The advertisement panel may have less than an 80 percent opacity to allow viewing of the product through the advertisement from an outer side of the transparent panel.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a front view of the outside of a display cabinet according to an embodiment of the present invention;

FIG. 2 is a rear view of the inside of a display cabinet door of the display cabinet in FIG. 1;

FIG. 3 is a flow chart illustrating an advertising method according to an embodiment of the present invention; and

FIG. 4 is a front view of an alternative display cabinet according to another embodiment of the present invention.

### DETAILED DESCRIPTION OF PREFERRED EMBODIMENTS

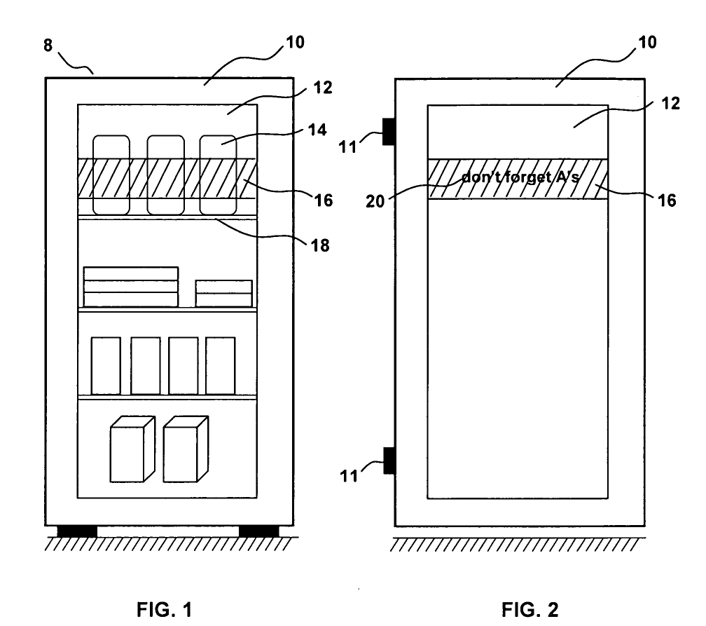

FIG. 1 illustrates retail display cabinet 8 with door 10 and transparent door panel 12 onto which is applied one-way vision, see-through advertisement panel 16. The cabinet 8 is disposed in a retail store to display and contain displayed products 14. The panel 16 includes a dark, typically black, silhouette pattern facing an outer side of the door panel 12, thereby allowing good vision by an observer located outside the cabinet 8 of the displayed product(s) 14 on a shelf 18 inside the cabinet 8. FIG. 2 illustrates an inner side of the cabinet door 10 with the one-way vision advertisement panel 16 with an advertisement 20 (e.g., “don't forget A's”) visible from the inner side of the door 10. The advertisement 20 may be for an advertised product or service. The door 10 is hinged via hinges 11 to the cabinet 8.

When the door 10 is closed, the advertisement panel 16 allows a substantially unobstructed view from an outer side of the door 10 through the advertisement panel 16 and advertisement 20 to the product 14. As viewed from the outside of the door 10, the advertisement 20 is substantially invisible. Accordingly, a customer/observer can identify and select the product 14 for purchase by viewing the product 14 through the advertisement panel 16 and advertisement 20.

The silhouette pattern of one-way vision panels such as the panel 16 typically creates a greytone “tint” when a customer views into the cabinet 8 from the outer side of the door 10. The customer nonetheless maintains a substantially unobstructed view of the contents of the cabinet 8 through the advertisement 20 and silhouette pattern.

The use of an inwardly-facing one-way vision advertisement panel 16 on the door 10 advantageously avoids significantly cluttering the outward appearance of the cabinet 8. Consequently, a customer viewing the products 14 in the cabinet 8 will not be overly distracted by the advertisement panel 16 before opening the door 10.

In the embodiment illustrated in FIGS. 1 and 2, when a customer opens the door 10, the customer is exposed to the inner side(s) of the door 10, transparent panel 12, and advertisement panel 16, which permits the customer to view the advertisement 20. Consequently, only after choosing to open the door 10 does the customer clearly see the advertisement 20. The advertisement 20 may be used to reinforce the sale of the product 14. Alternatively, the advertisement 20 may be used to cross-sell a product in a different cabinet or on another shelf in the retail store, typically in a different product category, for example, a complimentary product or service. Alternatively, the advertisement 20 may promote a competing product in an attempt to divert a purchase from the displayed product 14 to the advertised product.

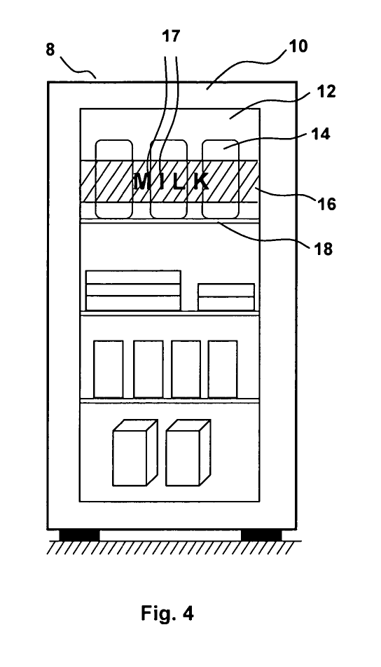

As shown in FIG. 4, a sign or an advertisement 17 may be provided on the advertisement panel 16 and be visible from the outer side of the door 10. For example, as illustrated in FIG. 4, a sign 17 may identify the category of products within the cabinet 8 (e.g., “MILK”). Alternatively, an advertisement 17 may promote the products 14 or other products within the cabinet 8 or promote other products outside cabinet 88. The design of such a sign or advertisement 17 is preferably also superimposed on the silhouette pattern of a one-way vision panel such that the sign or advertisement 17 is not visible from the inner side of the door 10. Unprinted portions within the sign or advertisement 17 ensure that they do not significantly interfere with a customer's view into the cabinet 8, unlike, for example, the discrete indicia of the prior art. Accordingly, the customer's view of the product 14 through the sign or advertisement 17 remains substantially unobstructed. Advertisement panel 16 displaying sign or advertisement 17 visible from the outer side of the door 10 may also display an advertisement 20 visible from the inner side of the door 10.

The advertisement panel 16 may be made according to US RE37,186 or may be made according to any other suitable one-way vision teaching. The advertisements 20 may have a relatively fine pattern of dots or lines and a “percentage opacity” from 50% to 80%, and preferably not greater than 60%, preferably leaving at least 40% transparency to enable substantially unobstructed through-vision of the products 14 inside the cabinet 8. An example of a suitable silhouette pattern for the advertisement panel 16 is a pattern of lines 1.2 mm thick at 2.0 mm centers, or preferably 0.6 mm thick lines at 1.0 mm centers, the advertisement 20 design being superimposed with substantially exact registration onto the silhouette pattern. A self-adhesive assembly according to one embodiment of the present invention comprises a 50μ thick print-treated polyester facestock with a removable, acrylic-based or urethene-based pressure-sensitive adhesive and a release liner. The release liner may be a silicone-coated polyester or paper liner, which is removed immediately before the advertisement is applied to the cabinet door 10. When such advertisement panels 16 are applied to external windows or glass partitions, a water-based application fluid may be used to assist in the removal of air when squeegeeing the advertisement onto the window, a method which is optional used with the present invention. However, the application process is preferably quick and easy and does not substantially delay customers who wish to access any cabinet 8, even if a panel 16 is applied during shopping hours. It has been found that conditions on the inside surface of a cooler cabinet door, for example the presence of condensation, allow the application of advertisement panels 16 to the inside of a door without the use of an application fluid.

The product 14 and other contents of the display cabinet 8 are typically illuminated by a source of illumination in the cabinet 8. Preferably, this source of illumination is near the top of the cabinet 8 and/or on the opposite side of the cabinet from the door hinges 11 to best illuminate the advertisement 20 upon opening of door 10. A specific source of illumination may be directed toward the advertisement 20 upon opening the door 10. The specific source of illumination can be switched on momentarily to highlight the advertisement 16 for example activated by a switching mechanism which is triggered upon opening the door 10. The sources of illumination may be of any type (e.g., fluorescent tubes, fiber optic illumination, incandescent lights, etc.).

The panel 16 may be placed on the inside or outside of the door 10, and the advertisement 20 may be positioned either side of the panel 16. The advertisement panel 16 on the cabinet door 10 should be suited to the temperature, humidity, the transparent material of the panel 12 on which it is posted. The advertisement panel 16 should not present a health hazard to the products 14 on display. The one-way vision advertisement panel 16 is preferably an imperforate one-way vision advertisement rather than a perforated one-way vision advertisement, the latter being more likely to collect dirt in the perforation holes. The retailer may establish quality control standards in the specification of the pressure-sensitive adhesive, the plastic film facestock and the “silhouette pattern” on which the advertisement design is superimposed, for example of lines or dots, advertisement size options and posting locations, advertisements typically being positioned by means of a jig or guide mark on the door, so that advertisements may be aligned vertically for aesthetic reasons.

The advertisement panel 16 and advertisement 20 may be of any suitable size and shape. In one embodiment, a 24″×6″ advertisement panel 16 is used and is designed to be seen from about 1 to 2 feet away. The 24″×6″ panel 20, viewed from 2 feet away, is as easily visible as a 40′×10′ billboard viewed from 40 feet away.

As discussed above, the entity supplying the product 14 in the cabinet, as well as the retail store owner, have traditionally disfavored the use of display door advertisements. The use of one-way vision advertisement panels 16 mitigates such parties' concerns by limiting the “clutter” viewed from outside the cabinet 8, and by limiting the distracting nature of the advertisement 20 when viewed from the outside of the door 10.

Alternatively, as shown in FIG. 4, the advertisement panel 16 may have a translucent, typically white, base pattern according to U.S. Pat. No. 6,212,805 onto which an advertisement 17 is superimposed. The advertisement is visible from outside the cabinet 8 when the door 10 is closed but still enables through vision of products 14 inside the cabinet. A feature of this latter arrangement is that the advertisement 17 is typically illuminated from the other side of the advertisement panel 16 by artificial illumination inside the cabinet 8.

To further mitigate or eliminate the concerns with the use of advertisements on retail display cabinet doors 10, an embodiment of the present invention provides a method by which the entity whose product 14 is displayed in the cabinet 8 and/or the retailer and/or the owner of the cabinet 8 are directly or indirectly paid in exchange for granting permission to allow an advertisement 20 and/or advertisement 17 to be placed on the cabinet door 10.

Space for an advertisement panel 16 may be leased to a second entity to promote the second entity's products or services. This so-called space advertisement service may be managed by the retailer or by a space advertising contractor typically appointed by the retailer. The space advertising contractor leases the space to advertise another product or service, typically supplied by another entity than the entity that supplies the product 14 located in the cabinet 8 behind the advertisement 20 and/or advertisement 17. Alternatively, the retailer may lease the advertising space itself, in effect being its own space advertising contractor.

In one embodiment, the retailer reserves the top one or two shelves in a number of display cabinets in a store for its own retailer-branded products and leases the space for the advertisement panel 16 in front of these “own brand” products.

The leasing payments for the advertising space may be divided between the retailer, the first entity whose product 14 is displayed in the cabinet 8 behind the advertisement 20 and/or advertisement 17, and/or the owner of the cabinet 8 to convince such retailers/entities to grant permission for such advertisement panels 16 to be placed on the cabinet 8. If multiple entities have products 14 displayed within the cabinet, the payments may be divided appropriately between such entities. Payments may include money and/or any other type of suitable consideration (e.g., giving the first entity preferred cabinet 8 shelf space, etc.).

According to another embodiment of the present invention, the concerns of the entity whose product 14 is displayed in the cabinet 8 are mitigated by having the advertisement 20 and/or advertisement 17 promote a product or service of that same entity. The advertisement 20 and/or advertisement 17 may promote the products 14, may promote the first entity's complimentary products or services, or may cross-sell other products or services. The advertised goods or services may be available in cabinet 8, in another nearby or distant cabinet or shelf in the retail store, and/or outside of the retail store (e.g., another retail store, another building, etc.). According to one or more embodiments in which the products 14 and the advertisement 20 and/or advertisement 17 are of the same entity, obtaining permission to place an advertisement on the transparent panel is implicit without any express permission being required but within such a single entity, permission may still be required or obtained from one part of the entity, for example the brand manager of a product 14, to allow another product brand of the same entity to be advertised in front of product 14.

“Cross-selling” as used herein means that an advertisement in front of one product promotes another product or service. Cross-selling may also include joint promotional offers, for example an advertisement in front of sandwiches in a cooler cabinet promoting complementary soft drinks or potato chips to be purchased elsewhere in the store, perhaps at a reduced total price. The cross-selling advertisements can be of many types, for example:
(i) brand reinforcement, typically concentrating on the brand trademark or trademarks and/or an image of the another product being advertised,
(ii) a call to buy, for example “don't forget the XXXX” where XXXX is the another brand or service, or
(iii) promotional advertisements, for example “2 for the price of 1” promotions, or
(iv) new product introductions, for example new flavors for a toothpaste brand.

The first entity may be the owner of the retail store. The displayed product 14 and the advertised product or service may both be supplied by the retailer of the store in which the display cabinet 8 is located (e.g., store branded goods or services). The retailer preferably also owns the display cabinet 8. If the retailer (or its agent) applies the advertisement panel 16, the retailer can ensure that any adhesive used to adhere the panel 16 to the cabinet 8 will not damage the cabinet 8. This removes potential conflict between the advertiser and the cabinet owner who might be concerned about possible adhesive transfer, scratches, or other effects of cleaning off any adhesive which transfers to the cabinet 8 upon removal of the advertisement panel 16.

Additional conflicts are avoided by having the retailer be both the advertising entity and the entity whose product 14 is displayed. The retailer has total, non-contentious control over the retail environment without having to monitor, possibly object to, and possibly censor another entity's advertisement. The retailer also has an incentive to ensure that the advertisement is properly posted, for the required duration, and is motivated to replace it if it becomes damaged or falls off the cabinet door. There are a range of other potential benefits if the retailer is also the advertiser. For example, the product on display behind the cabinet door advertisement can be advertised in advance, for example by another one-way vision advertisement on or adjacent to the entrance doors of the retail store, which will not only encourage entering customers to buy the products on display in the cabinet but also then see the cooler door advertisement for the other product or service. Such an arrangement increases sales promotion without adding to the general clutter of promotion. Such mutually beneficial advertisements would be difficult to arrange unless the retailer owned both the product 14 inside the cabinet 8 and the product or service advertised on the cabinet door 10.

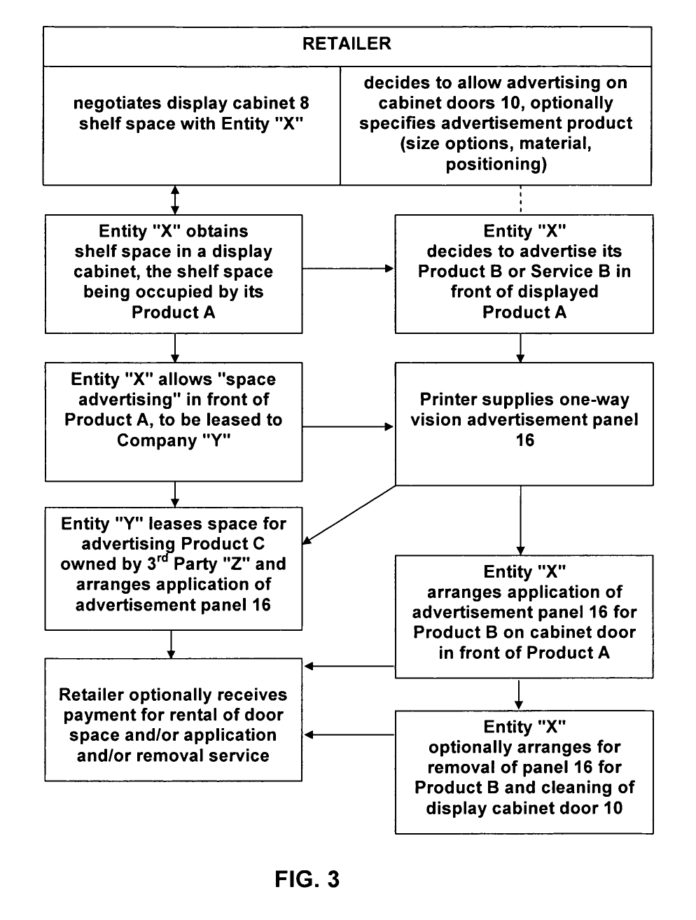

FIG. 3 illustrates a flowchart of an advertising method according to an embodiment of the present invention.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A method of providing an advertisement on a retail display cabinet having a door with a transparent panel, the cabinet containing at least one product supplied by a first entity, the method comprising:
obtaining permission from the first entity to place an advertisement panel on the transparent panel; and
placing on the transparent panel a one-way vision, see-through advertisement panel having the advertisement thereon, the advertisement panel having less than an 80 percent opacity to allow viewing of the at least one product through the advertisement from an outer side of the transparent panel, the advertisement being visible from an inner side of the transparent panel, the advertisement being substantially invisible from an outer side of the transparent panel.

2. The method of claim 1, further comprising providing consideration to the first entity in exchange for granting permission to place the advertisement panel on the transparent panel.

3. The method of claim 2, further comprising leasing advertising space on the transparent panel to a second entity, wherein the advertisement promotes a product or service of the second entity.

4. The method of claim 1, wherein the advertisement panel has less than a 60 percent opacity.

5. The method of claim 1, wherein the cabinet is disposed in a retail store, wherein the method further comprises obtaining permission from the owner of the retail store to place the advertisement panel on the transparent panel.

6. The method of claim 5, further comprising providing consideration to the owner of the retail store in exchange for granting permission to place the advertisement panel on the transparent panel.

7. The method of claim 1, wherein the advertisement promotes a product or service of a second entity.

8. The method of claim 7, wherein the cabinet is disposed in a retail store, and wherein the second entity is the owner of the retailer store.

9. The method of claim 1, wherein the cabinet is disposed in a retail store, wherein the first entity is the owner of the retailer store, and wherein the at least one product is a brand of the first entity.

10. The method of claim 1, wherein the cabinet is disposed in a retail store, and wherein the advertisement promotes a product or service available in the retail store.

11. The method of claim 1, wherein the cabinet is disposed in a retail store, and wherein the advertisement promotes a product or service that is not available in the retail store.

12. The method of claim 1, wherein the advertisement promotes a product or service of the first entity.

13. A method of advertising comprising:
placing a product in a retail display cabinet having a door with a transparent panel; and
placing on the transparent panel a one-way vision, see-through advertisement panel having an advertisement thereon, the advertisement panel allowing a substantially unobstructed view through the advertisement to the product from an outer side of the transparent panel, the advertisement being substantially invisible from an outer side of the transparent panel, the advertisement being visible from an inner side of the transparent panel,
wherein an entity whose product is placed in the cabinet is the entity whose advertisement is placed on the transparent panel, and
wherein the advertisement promotes a product or service in a location outside the cabinet.

14. The method of claim 13, wherein the advertisement panel has less than an 80 percent opacity to allow viewing of the product through the advertisement from an outer side of the transparent panel.

15. The method of claim 13, wherein said entity owns said cabinet.

16. The method of claim 13, wherein said entity owns a retail establishment in which said cabinet is located.

17. The method of claim 16, wherein:
said entity owns said cabinet; and
one of (i) said entity, and (ii) said entity's agent applies said advertisement panel to said transparent panel.

18. The method of claim 13, wherein one of (i) said entity, and (ii) said entity's agent places said advertisement panel on said transparent panel.

19. A method of advertising comprising:
placing a product in a retail display cabinet having a door with a transparent panel; and
placing on the transparent panel a see-through advertisement panel having an advertisement thereon, the advertisement being visible from an outer side of the transparent panel, the advertisement panel allowing a substantially unobstructed view through the advertisement to the product from an outer side of the transparent panel,
wherein an entity whose product is placed in the cabinet is the entity whose advertisement is placed on the transparent panel, and
wherein the advertisement promotes a product or service.

20. The method of claim 19, wherein at least 40% of an area of the transparent material is unprinted.

21. The method of claim 19, wherein said entity owns said cabinet.

22. The method of claim 19, wherein said entity owns a retail establishment in which said cabinet is located.

23. The method of claim 22, wherein:
said entity owns said cabinet; and
one of (i) said entity and (ii) said entity's agent applies said advertisement panel to said transparent panel.

24. The method of claim 19, wherein one of (i) said entity, and (ii) said entity's agent places said advertisement panel on said transparent panel.

25. The method of claim 19, wherein said advertisement is illuminated by artificial illumination inside said cabinet.
